(19) United States
(12) Patent Application Publication
(10) Pub. No.: US 2004/0098468 A1
(43) Pub. Date: May 20, 2004

(54) Multi internet service provider system and method of the same

(76) Inventor: Jung Ho Kang, Seoul (KR)

Correspondence Address: BIRCH STEWART KOLASCH & BIRCH, PO BOX 747, FALLS CHURCH, VA, 22040-0747, US

(21) Appl. No.: 10/467,087

(22) PCT Filed: Jan. 28, 2002
(86) PCT No.: PCT/KR02/00125

(30) Foreign Application Priority Data
Feb. 19, 2001 (KR) 2011-08216

(51) Int. Cl. G06F 15/16

(52) U.S. Cl. 709/219

(57) ABSTRACT

Disclosed in the present invention is a multi Internet service provider (hereinafter, it is abbreviated as ISP) system and implementation method thereof, in which a plurality of ISP operators share one single ISP system to provide Internet services to each ISP subscriber, by pre-storing the information about the online connecting means connected to the personal computer of the user who wants to transceive the online information with the external online network through the online network of the subscribed ISP and the information about the IP address the ISP uses to the IP address assigning means, finding out the information on the PC and the online connecting means in case the PC intends to access to the ISP online network, and connecting the PC and the online connecting means to the subscribed ISP online network out of the plurality of ISP online networks. Accordingly, the present invention is very useful for preventing duplicated investment on the same facilities like the ISP system, and preventing national economic loss.

### BACKGROUND OF THE INVENTION

1. Field of the Invention

The present invention relates to a multi Internet service provider (hereinafter, it is abbreviated to ISP) and implementation method thereof. In particular the present invention relates to a multi ISP system and implementation method, which enables a plurality of ISP operators to provide Internet access using an identical ISP system.

2. Description of the Related Art

As more people use online network like Internet to transmit/receive information, ISP operators helping those users to connect to the online network through personal computer have been greatly increased also.

As shown in FIG. 1, the Internet users through ISP are connected to a hub 5 through a cable modem 2 connected to their own PCs 1, where the hub 5 is connected to cable modem termination system (CMTS) 4 in hybrid fiber coaxial cable (HFC) 3 network using coaxial cable and optical fiber cable to transmit broadband content including video, data, voice and so forth.

Here, the hub 5 is again connected to dynamic host configuration protocol (DHCP) server 6 in order to assign IP address an ISP of an ISP operator who subscribed the cable modem 2 uses to the PC 1 and the cable modem 2. Also, the hub 5 is connected to a router 8 which transceives online information of the PC 1 over the online network of the subscribed ISP, having the online information of the PC 1 through the hub 5 is transceived with external online network.

Thusly configured ISP system of the related art is operated as follows.

First of all, the cable modem 2 connected to the PC 1 receives a private IP address from the DHCP server 6 after it having been connected to the CMTS 4. Once the private IP address is assigned to the cable modem 2, the PC 1 receives a licensed IP address from the DHCP server 6.

Later, to input a host IP address of an Internet network the user wants to access or a domain name into a web browser, the router 8, it being connected to the Internet network of the ISP to which the cable modem 2 that assigned the licensed IP address to the PC 1 is connected, performs a dynamic routing function to get the PC 1 to be connected to the host of the external online network 9.

Unfortunately however, in such ISP system, the ISP operator had to operate a separate ISP system to provide services like very high speed Internet access services to PC users using the HFC network.

More specifically, for every ISP operator operated a separate ISP system, the frequency bandwidth to be distributed or supplied to a number of ISP operators was limited, causing a frequency bandwidth deficiency problem.

In addition, if an ISP system using a communication protocol having the same cable modem with the CMTS is used, the connection time of the CMTS and the cable modem is delayed. Further, in the event that one CMTS out of a plurality of CMTS fails, the cable modem connected to the failed CMTS will keep trying to connect to other CMTS. This degrades the performance of the normal CMTS and consequently degrades service quality the operator wants to provide.

For such reasons, not many people agree on that there is no problem for a plurality of ISP operators to provide very high speed Internet services to the subscribers at the same time, using the identical ISP system.

In fact, when the plural ISP operators implement the ISP system to provide a separate ISP service to the subscribers, the ISP operators cannot use the same CMTS and router, which means that every ISP operator requires a separate CMTS and a router, costing a great amount of money for just implementing the CMTS and routers. Besides, it is highly possible that a nation might suffer from excessive duplicated investment on the same system that unfortunately caused a great economic loss.

### SUMMARY OF THE INVENTION

It is, therefore, an object of the present invention to provide a multi Internet service provider (ISP) system and implementation method thereof, which enables a plurality of ISP operators to provide Internet access service to each ISP subscriber through an identical ISP system.

It is another object of the present invention to provide a multi ISP system and implementation method thereof, which prevents an excessive economic loss due to duplicated investment on an identical facility and further decreases expense on local telecommunication industries, by having a plurality of ISP operators share an ISP system.

To achieve the above objects, there is provided a multi Internet service provider system implementation method applicable to an online network which connects a plurality of online connecting means connected to a personal computer with a plurality of Internet service providers to get the personal computer to be accessed to an external online network by assigning an IP address to the online connecting means, the method including the steps of: storing information about Internet Protocol (IP) address the plurality of ISP use, respectively, and information about the online connecting means that is subscribed to the ISP into an IP address assigning means which connects the online connecting means with the ISP online network over the online network; assigning an IP address an ISP uses, to which the online connecting means is subscribed, to the personal computer in accordance with the stored information, in time of connecting the personal computer to the IP address assigning means by using the online connecting means; and transceiving, at the personal computer, online information from an external online network as transceiving information of the personal computer is transceived to the subscribed ISP online network through a routing means in accordance with the IP address assigned to the personal computer.

Another aspect of the present invention provides a multi Internet service provider system in an online network which connects a plurality of online connecting means connected to a personal computer with a plurality of Internet service providers to get the personal computer to be accessed to an external online network by assigning an IP address to the online connecting means, the system including: an IP address assigning means which connects the online connecting means with the ISP online network over the online network, and stores information about IP address the plurality of ISP use, respectively, and information about an online connecting means that is subscribed to the ISP; and a routing means which enables the personal computer to transceive online information with an external online network by making the information of the personal computer be transceived to the subscribed ISP online network in accordance with the IP address assigned to the personal computer, wherein the personal computer is assigned with an IP address of the ISP to which the online connecting means is subscribed in accordance with the information stored in the IP address assigning means, in time of accessing to the IP address assigning means by using the online connecting means.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram illustrating a configuration of Internet Service Provider (ISP) system according to a related art;

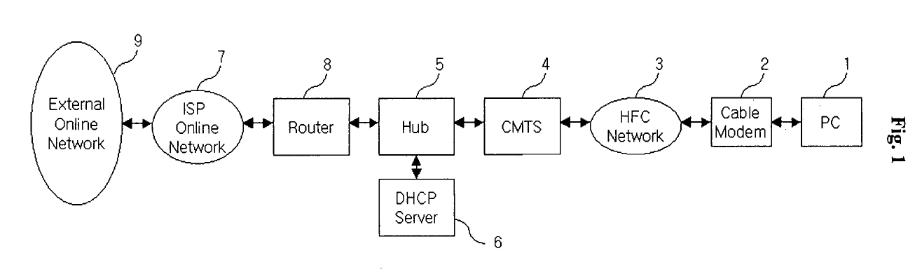

FIG. 2 is a block diagram illustrating a multi ISP system according to a first embodiment of the present invention;

FIG. 3 is a block diagram illustrating a multi ISP system according to a second embodiment of the present invention;

FIG. 4 is a block diagram illustrating a packet which is transmitted from a multi ISP system according to the present invention;

FIG. 5 is a flow chart illustrating operations of a multi ISP system according to the present invention; and

FIG. 6 is a flow chart illustrating a method for assigning IP address in a multi ISP system according to the present invention.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

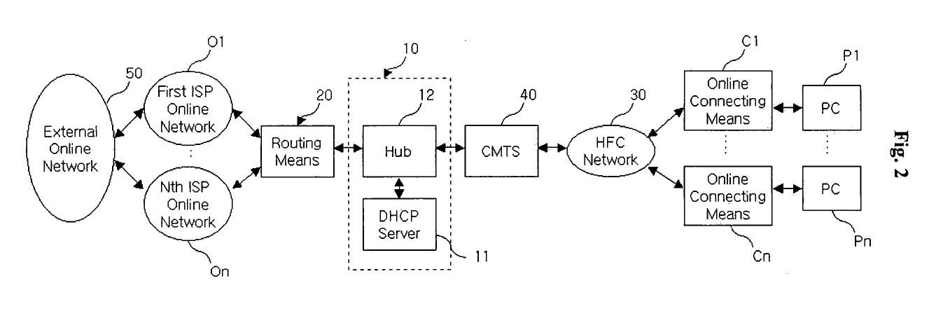

As depicted in FIG. 2, the multi Internet service provider (ISP) system according to the present invention includes online connecting means C1 through Cn, which are connected to a personal computer (PC) P1 through Pn of a user who subscribed to a plurality of ISP; an IP address assigning means 10, which assigns an IP address being used by an ISP with the subscribed online connecting means C1 through Cn to the PC P1 through Pn using the online connecting means C1 through Cn; and a routing means 20, which enables to transceive online information with an external online network 50 through an ISP online network O1 through On, to which the PC having the IP address assigned by the IP address assigning means 10 is subscribed.

Here, the online connecting means C1 through Cn connected to the PC P1 through Pn is connected to the IP address assigning means 10 through cable modem termination system (CMTS) 40 over hybrid fiber coaxial cable (HFC) 30 that uses coaxial cable and optical fiber cable for conveying bandwidth content including video, data, voice and so forth.

Further, the IP address assigning means 10 includes DHCP server 11 which assigns IP address of the ISP having the subscribed online connecting means C1 through Cn to the PC P1 through Pn that is connected to the online connecting means C1 through Cn, and a hub 12 which connects the DHCP server 11 and the online connecting means C1 through Cn.

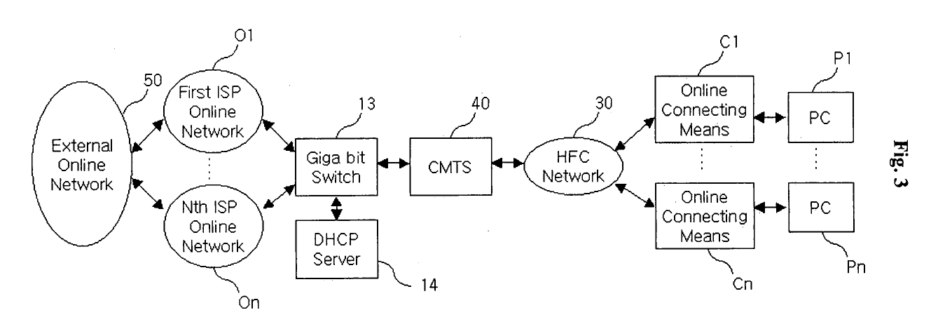

On the other hand, another preferred embodiment of the present invention shown in FIG. 3 includes giga bit switch 13 and DHCP server 14 on behalf of the IP address assigning means 10 and the routing means 20 illustrated in FIG. 2. Here, the giga bit switch 13 optically transmits the online information that is transceived between the online connecting means C1 through Cn and the external online network. And, the DHCP server 14 assigns the IP address of the ISP, to which the online connecting means C1 through Cn is subscribed, to the PC P1 through Pn through the giga bit switch 13.

Preferably, cable modem is generally used for the online connecting means C1 through Cn, and the routing means 20 includes a router.

Here, the IP address assigning means 10 predetermines a block for storing information about private IP addresses and licensed IP addresses each ISP uses, and at the same time, it stores information about the online connecting means C1 through Cn that are subscribed to the ISP. In this way, when the PC P1 through Pn intends to transceive the online information with the external online network 50 through the online connecting means C1 through Cn, the IP address assigning means 10 collects the information on the online connecting means C1 through Cn, assigns the private IP address of the ISP to which the online connecting means C1 through Cn are subscribed, and then assigns the licensed IP address of the ISP, which assigned the private IP address to the online connecting means C1 through Cn, to the PC P1 through Pn.

In other words, if the user wants to exchange online information with the external online network through the first ISP online network O1 by subscribing the first ISP, he or she first accessed to the IP address assigning means 10 through the online connecting means C1 that is connected to his or her PC P1.

As the online connecting means C1 is connected to the IP address assigning means 10, the IP address assigning means 10, in accordance with the pre-stored information about the online connecting means that is subscribed to the ISP, confirms whether the online connecting means C1 is subscribed to the ISP.

Particularly, the IP address assigning means 10 in this embodiment stores media access control (MAC) address information, the information about data hierarchy address of the online connecting means C1, in order to distinguish the online connecting means C1, and assigns the private IP address the subscribed ISP uses to the online connecting means C1, after confirming that the online connecting means which is accessed to the IP address assigning means 10 has been subscribed to the ISP and using the MAC address information. Another information besides the MAC address can be used for distinguishing the online connecting means C1 is tag information, which is what the ISP gives to the online connecting means C1 when the online connecting means subscribes to the ISP.

After the private IP address is assigned to the online connecting means C1, the PC P1 connected to the online connecting means C1 transmits a packet including the MAC address information of the online connecting means C1 to the IP address assigning means 10.

Upon receiving the MAC address information of the online connecting means C1 from the PC P1, the IP address assigning means 10 assigns the licensed IP address of the ISP to which the MAC address is subscribed to the PC P1, thereby enabling the PC P1 to exchange the online information with the external online network 50 via the ISP online network O1 the PC P1 has subscribed through the licensed IP address.

After the licensed IP address is assigned to the PC P1, the user of the PC P1 inputs the IP address or domain name of a host who wants to transceive the online information into a web browser in order to access to the host.

In such case, the online information the PC P1 plans to transceive with the external online network is sent out to the ISP online network O1 through the routing means 20, or the router. Here, the router recognizes the source of the PC P1, that is, the licensed IP address assigned to the PC P1, and using the IP address assigning means 10, it decides which ISP uses the IP address.

When the PC P1 uses the first ISP online network O1, the router transceives the online information of the PC P1 with the first ISP online network O1, which enables the PC P1 to transceive the online information with the external online network 50 through the online network of a specific ISP out of a plurality of ISP, to which the PC P1 particularly subscribed,

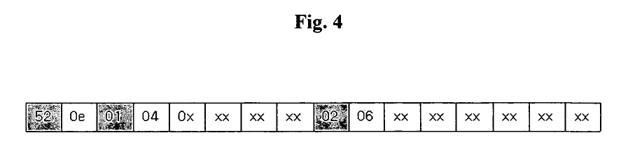

FIG. 4 illustrates a packet that the online connecting means and the PC transmits to the IP address assigning means in the multi ISP system according to the present invention.

The packet includes a definition block 52 for defining the packet; a packet length block Oe for manifesting the length of the packet; a first data sorting block 01 for manifesting the types of the first data arrayed later; a first data length block 04 for manifesting the length of the first data; a first data block 0x, xx, xx, xx including the first data, which indicates whether the packet is transmitted from the online connecting means or form the PC; a second data sorting block 02 for manifesting the types of the second data arrayed later; a second data length block 06 for manifesting the length of the second data; and a second data block xx, xx, xx, xx, xx, xx composed of the MAC address information of the online connecting means.

Using the data of the first block 0x data of the first data block, the IP address assigning means finds out which transmitted the packet, the cable modem or the PC.

That is to say, if the packet is transmitted from the cable modem, the first block of the first data block takes 00 for the data value, but if the packet is transmitted form the PC, the first block takes 01 for the data value.

Accordingly, in case the definition block of the transmitted packet has the data value 52, and the first block has the data value 00, the IP address assigning means confirms the MAC address of the online connecting means if the online connecting means has been accessed to the IP address assigning means, and assigns the private IP address of the ISP, to which the MAC address subscribed, to the online connecting means.

On the other hand, in case the definition block of the transmitted packet has the data value 52, and the first block has the data value 01, the IP address assigning means confirms the MAC address of the online connecting means if the PC has been accessed to the IP address assigning means, and assigns the licensed IP address of the ISP, to which the MAC address subscribed, to the PC.

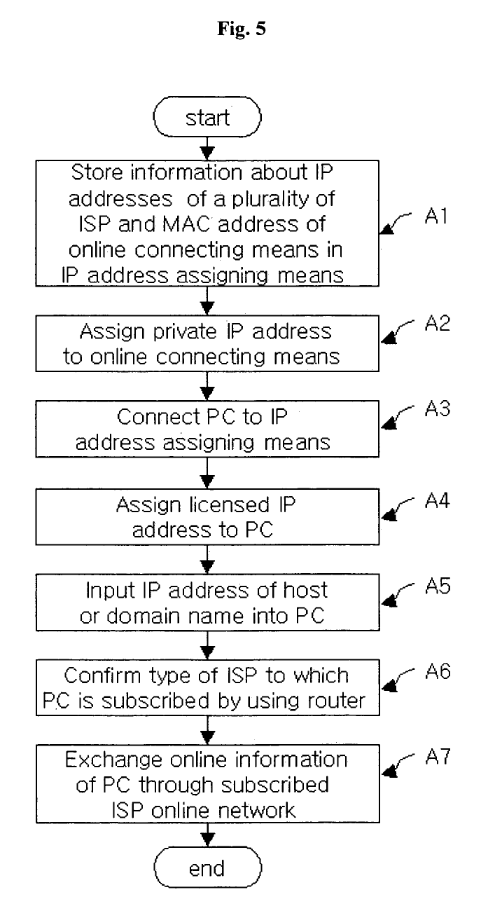

The operation of thusly configured system is now explained with reference to FIG. 5.

First of all, in the first step, the IP address assigning means stores the information about the private IP addresses and licensed IP addresses the plural ISP use, respectively, and the information about the MAC address of the online connecting means which is subscribed to the ISP (A1).

In the second step, in case the online connecting means, being subscribed to the ISP, is accessed to the IP address assigning means, the IP address assigning means confirms the MAC address of the online connecting means, and assigns the private IP address of the ISP to which the MAC address is subscribed to the online connecting means (A2).

In the third step, as the online connecting means receives the private IP address from the IP address assigning means, the PC accesses to the IP address assigning means (A3).

In the fourth step, as the PC assess to the IP address assigning means, the IP address assigning means assigns the licensed IP address of the ISP to which the MAC address is subscribed to the PC, in accordance with the MAC address of the online connecting means included in the packet the PC transmitted (A4).

In the fifth step, after the licensed IP address of the subscribed ISP is assigned, the PC inputs the IP address of the host or domain name into the web browser, in order to transceive the online information with the external online network (A5).

In the sixth step, as the PC intends to transceive the online information with the external online network, the routing means which transceives the online information of the PC with the ISP online network recognizes the source address of the PC, that is, the licensed IP address assigned to the PC, and through the IP address assigning means, confirms which ISP is using the licensed IP address (A6).

In the seventh step, after confirming which ISP the PC is subscribed to, the routing means transceives the online information of the PC with the online network of the ISP the PC subscribed to, in order to enable the PC to transceive desired information with the external online network through the subscribed ISP (A7).

Here, depending on the type of the ISP system, the second through fourth steps can be omitted. That is, the PC can be connected to the IP address assigning means directly, and receive the IP address of the ISP the PC subscribed. Then, the PC can transceive the online information with the ISP online network, and eventually exchange the online information with the external online network.

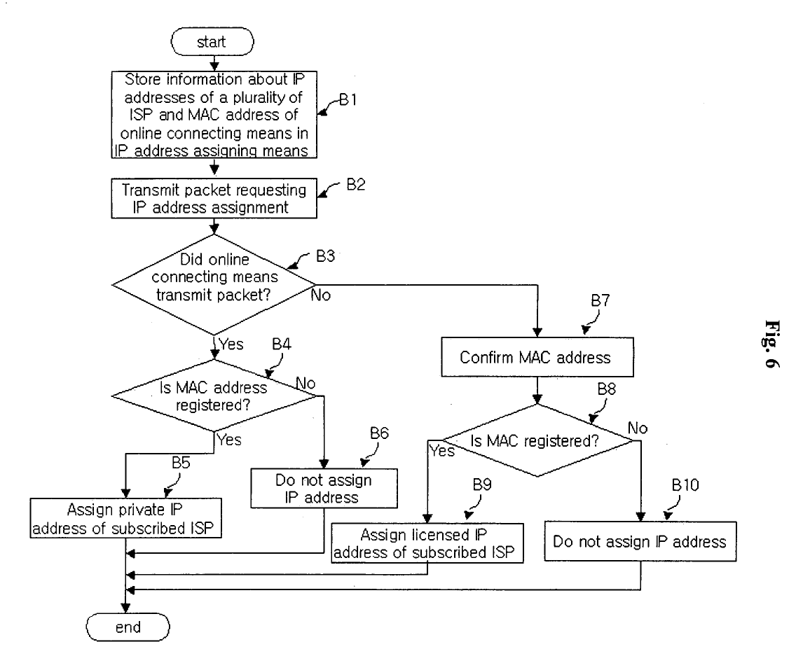

Next, referring to FIG. 6, it is explained how the IP address assigning means assigns the IP addresses.

To begin with, in the first step, the IP address assigning means stores the information about the private IP addresses and licensed IP addresses the plural ISP use, respectively, and the information about the MAC address of the online connecting means which is subscribed to the ISP (B1).

In the second step, the packet like the one illustrated in FIG. 4 for requesting the IP address assignment is transmitted to the IP address assigning means (B2).

In the third step, upon receiving the packet, the IP address assigning means confirms the first block of the first data block in the packet, and decides whether the online connecting means transmitted the packet or the PC transmitted the packet (B3).

In the fourth step, if it turns out that the online connecting means transmitted the packet to the IP address assigning means, the IP address assigning means confirms the MAC address of the online connecting means and then confirms whether the MAC address is stored in the IP address assigning means (B4).

In the fifth step, in case the MAC address of the online connecting means is stored in the IP address assigning means, the IP address assigning means selects the ISP to which the MAC address is subscribed out of a plurality of Internet service providers, and assigns the private IP address the ISP uses to the online connecting means (B5).

In the sixth step, in case the MAC address of the online connecting means is not stored in the IP address assigning means, the IP address assigning means recognizes that there is no ISP to which the online connecting means is subscribed, and decides not to assign the IP address accordingly (B6).

In the seventh step, if it turns out that the PC transmitted the packet to the IP address assigning means, the IP address assigning means confirms the information about the MAC address of the online connecting means includes in the second data block of the packet (B7).

In the eighth step, similar to the step 4, the IP address assigning means confirms whether the MAC address confirmed in the step 7 is stored in the IP address assigning means (B8).

In the ninth step, in case the MAC address is stored in the IP address assigning means, the IP address assigning means assigns the licensed IP address the ISP to which the MAC address is subscribed to the PC (B9).

In the tenth step, in case the MAC address is not stored in the IP address assigning means, the IP address assigning means does not assign the IP address to the PC (B10).

In conclusion, the multi ISP system and implementation method thereof according to the present invention is very useful for preventing duplicated investment on the same facilities like the ISP system, and preventing national economic loss in that it enables the plurality of ISP operators to share one single ISP system to provide the Internet services to the subscribes, by pre-storing the information about the online connecting means connected to the personal computer of the user who wants to transceive the online information with the external online network through the online network of the subscribed ISP and the information about the IP address the ISP uses to the IP address assigning means, finding out the information on the PC and the online connecting means in case the PC intends to access to the ISP online network, and connecting the PC and the online connecting means to the subscribed ISP online network out of the plurality of ISP online networks.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A multi Internet service provider (ISP) system implementation method applicable to an online network which connects a plurality of online connecting means connected to a personal computer with a plurality of Internet service providers to get the personal computer to be accessed to an external online network by assigning an Internet Protocol (IP) address to the online connecting means, the method comprising the steps of:
storing information about IP address the plurality of ISP use, respectively, and information about the online connecting means that is subscribed to the ISP into an IP address assigning means which connects the online connecting means with the ISP online network over the online network;
assigning an IP address an ISP uses, to which the online connecting means is subscribed, to the personal computer in accordance with the stored information, in time of connecting the personal computer to the IP address assigning means by using the online connecting means; and
transceiving, at the personal computer, online information from an external online network as transceiving information of the personal computer is transceived to the subscribed ISP online network through a routing means in accordance with the IP address assigned to the personal computer.

2. The method according to claim 1, wherein the IP address assigning means stores information about private IP addresses and licensed IP addresses the Internet service providers use, respectively.

3. The method according to claim 1, wherein the IP address assigning means stores information about the online connecting means to distinguish the online connecting means connected to the IP address assigning means.

4. The method according to claim 1, wherein the IP address assigning means stores information about data link hierarchy address of the online connecting means.

5. The method according to claim 1, wherein the step of assigning the IP address to the personal computer further comprises:
a first connecting step, in which the online connecting means is connected to the IP address assigning means;
a first comparing step, in which the information about the data link hierarchy address of the connected online connecting means is compared with the information about the online connecting means stored in the IP address assigning means; and
a private IP address assigning step, in which, based on the comparison result, a private IP address of the ISP, to which the online connecting means is subscribed, is assigned to the online connecting means.

6. The method according to claim 1, wherein the step of assigning the IP address to the personal computer further comprises:
a second connecting step, in which the personal computer is connected to the IP address assigning means through the online connecting means;
a second comparing step, in which the information about the data link hierarchy address of the connected online connecting means is compared with the information about the online connecting means stored in the IP address assigning means; and
a licensed IP address assigning step, in which, based on the comparison result, a licensed IP address of the ISP, to which the online connecting means is subscribed, is assigned to the personal computer.

7. The method according to claim 5 or 6, wherein, if the data link hierarchy address of the online connecting means does not conform with the information about the online connecting means stored in the IP address assigning means, the connection made in the connecting step is released during the comparing step.

8. The method according to claim 5 or 6, wherein, if the data link hierarchy address of the online connecting means conforms with the information about the online connecting means stored in the IP address assigning means, the IP address assigning means assigns an IP address of the ISP, to which the data link hierarchy address is subscribed, during the IP address assigning step.

9. The method according to claim 1, wherein the step of transceiving online information between the personal computer and the external online network further comprises:
a connecting step, in which the personal computer is connected to the external online network through the assigned IP address;
an IP address recognizing step, in which the IP address of the personal computer to be connected to the external online network is recognized by a routing means that transceives online information of the personal computer;
an online information transceiving step, in which the routing means, after recognizing the IP address of the personal computer, transceives the online information of the personal computer to an ISP using the IP address; and
an online information exchanging step, in which, upon receiving the online information through the ISP to which the personal is subscribed, the personal computer exchanges the online information with the external online network.

10. The method according to claim 9, wherein, during the online information transceiving step, the routing means transceives the online information of the personal computer to the ISP by recognizing the information about the ISP that uses the IP address of the personal computer through the IP address assigning means.

11. A multi Internet service provider (ISP) system in an online network which connects a plurality of online connecting means connected to a personal computer with a plurality of Internet service providers to get the personal computer to be accessed to an external online network by assigning an Internet Protocol (IP) address to the online connecting means, the system comprising:
an IP address assigning means which connects the online connecting means with the ISP online network over the online network, and stores information about IP address the plurality of ISP use, respectively, and information about an online connecting means that is subscribed to the ISP; and
a routing means which enables the personal computer to transceive online information with an external online network by making the transceiving information of the personal computer be transceived to the subscribed ISP online network in accordance with the IP address assigned to the personal computer, wherein the personal computer is assigned with an IP address of the ISP to which the online connecting means is subscribed in accordance with the information stored in the IP address assigning means, in time of accessing to the IP address assigning means by using the online connecting means.

12. The system according to claim 11, wherein the IP address assigning means comprises a block for storing information about private IP addresses and licensed IP addressed the Internet service providers use, respectively.

13. The system according to claim 11, wherein the IP address assigning means comprises a block for storing information about a data link hierarchy address of the online connecting means.

14. The system according to claim 11, wherein the IP address assigning means comprising:
a dynamic host configuration protocol (DHCP) server for assigning the IP address of the ISP, to which the online connecting means is subscribed, to the personal computer, in accordance with the information stored in the online connecting means; and
a hub for connecting the DHCP server to the online connecting means.

15. The system according to claim 11, wherein the IP address assigning means and the routing means comprises a giga bit switch for optically transmitting the online information that is transceived between the online connecting means and the external online network, and a DHCP server for assigning the IP address of the ISP, to which the online connecting means is subscribed, to the personal computer through the giga bit switch.
